(19) United States
(12) Patent Application Publication
(10) Pub. No.: US 2025/0182942 A1
(43) Pub. Date: Jun. 5, 2025

(54) SOFT-MAGNETIC WIRE, SOFT-MAGNETIC STEEL BAR, AND SOFT-MAGNETIC COMPONENT

(71) Applicant: Kabushiki Kaisha Kobe Seiko Sho (Kobe Steel, Ltd.), Kobe-shi (JP)

(72) Inventor: Kenshi IKEDA, Kobe-shi (JP)

(73) Assignee: Kabushiki Kaisha Kobe Seiko Sho (Kobe Steel, Ltd.), Kobe-shi (JP)

(21) Appl. No.: 18/841,710

(22) PCT Filed: Feb. 21, 2023
(86) PCT No.: PCT/JP2023/006169

§ 371 Date: Aug. 27, 2024

(30) Foreign Application Priority Data
Mar. 10, 2022 (JP) 2022-037304
Nov. 22, 2022 (JP) 2022-186848

(51) Int. Cl. H01F 7/02; H01F 1/147

(52) U.S. Cl. CPC H01F 7/021; H01F 1/14766

(57) ABSTRACT

A soft magnetic wire rod or soft magnetic steel bar may include: Fe; C: 0.075% by mass or less; Si: 1.00% by mass or less; Mn: 0.10% by mass or more and 1.00% by mass or less; P: 0.100% by mass or less; S: 0.100% by mass or less; Cu: 1.00% by mass or less; Ni: 1.00% by mass or less; Cr: 1.00% by mass or less; Al: less than 0.030% by mass; N: 0.0200% by mass or less; and Sn: 0.002% by mass or more and 0.050% by mass or less; and inevitable impurities. The soft magnetic wire rod or soft magnetic steel bar may further include: ferrite at an area ratio of 80% or more, wherein the ferrite has a crystal grain size number of 5.0 or less. The soft magnetic wire rod or soft magnetic steel bar may have a Vickers hardness of HV 140 or less.

### TECHNICAL FIELD

The present disclosure relates to a soft magnetic wire rod and a soft magnetic steel bar, and a soft magnetic component.

### BACKGROUND ART

In response to the trend toward energy conservation in automobiles and other devices, most electrical components (especially electromagnetic components) in automobiles and the like are required to save power and be precisely controlled. In particular, steel materials that constitute magnetic circuits are required to have magnetic properties such as ease of magnetization under a weak external magnetic field and a low coercive force.

A soft magnetic steel material, in which the magnetic flux density inside the steel material easily responds to the external magnetic field, is normally used as the above steel material. Specifically, ultra-low carbon steel (pure iron-based soft magnetic material) having a C content of, for example, about 0.1% by mass or less is used as the above soft magnetic steel material. Forms of soft magnetic steel material that are commonly used include plates (electromagnetic steel sheets), wire rods, and steel bars. Among these, plates are often subjected to a relatively simple process to obtain soft magnetic components for use as electromagnetic components. On the other hand, in cases where a wire rod or steel bar is processed to produce a soft magnetic component, the wire rod or steel bar is often hot-rolled, followed by secondary processes, i.e., pickling, lubricating process, drawing, etc., to obtain a steel wire. This steel wire is then subjected to component forming (forging, cutting), magnetic annealing, and the like, in sequence. In recent years, from the viewpoint of reducing manufacturing costs, soft magnetic components have often been obtained by forming wire rods or steel bars through cold forging. Meanwhile, there are demands for more complicated shapes, higher dimensional accuracy, and lower manufacturing costs during forging. Additionally, soft magnetic wire rods or steel bars are required to have lower deformation resistance during cold forging.

Furthermore, electromagnetic components are required to have corrosion resistance depending on the operating environment. Electromagnetic stainless steel is used in a part of the component where this corrosion resistance is required. Electromagnetic stainless steel is a special steel that has both magnetic properties and corrosion resistance. Applications thereof include components that utilize magnetic circuits such as sensors, actuators and motors, and electromagnetic components that are used in corrosive environments.

As the above electromagnetic stainless steel, 13Cr-based electromagnetic stainless steel has been conventionally used. For example, Patent Document 1 describes a method for improving the cold forgeability and machinability of 13Cr-based electromagnetic stainless steel.

Meanwhile, for example, Patent Documents 2 and 3 disclose improvements in the strength and machinability of ultra-low carbon steel without degrading its magnetic properties by controlling its composition and the dispersed state of sulfides in the steel.

Patent Document 4 discloses a steel material achieving both corrosion resistance and magnetic properties, and its manufacturing method.

### CONVENTIONAL ART DOCUMENT

### Patent Document

Patent Document 1: JP H06-228717A
Patent Document 2: JP 2010-235976A
Patent Document 3: JP 2007-46125A
Patent Document 4: JP 2014-198874A

### SUMMARY OF THE INVENTION

### Problems to be Solved by the Invention

However, the 13Cr-based electromagnetic stainless steel disclosed in Patent Document 1 is difficult to process, and is less likely to have excellent cold forgeability, unlike ultra-low carbon steel. In addition, due to the high content of alloying elements, the material becomes expensive. When the prices of these elements surge, it can accordingly cause issues such as a significant increase in material cost and difficulty in supplying the material.

The ultra-low carbon steel disclosed in Patent Documents 2 and 3 have not considered cases where corrosion resistance is required, and it may not obtain sufficient corrosion resistance.

In a steel material disclosed in Patent Document 4, an amorphous layer is formed in a surface oxide film, thereby achieving both excellent corrosion resistance and magnetic properties. However, it is necessary to add 1% by mass or more of Si, which leads to issues such as high deformation resistance during cold forging, i.e., poor cold forgeability.

The present disclosure has been made in view of such circumstances, and it is an object of the present disclosure to provide a soft magnetic wire rod or soft magnetic steel bar and a soft magnetic component that have improved all of the magnetic properties, cold forgeability, and corrosion resistance, without adding a large amount of alloying elements.

### Solution to the Problems

Aspect 1 of the present invention provides a soft magnetic wire rod or soft magnetic steel bar, including:
C: 0.075% by mass or less (including 0% by mass);
Si: 1.00% by mass or less (including 0% by mass);
Mn: 0.10% by mass or more and 1.00% by mass or less;
P: 0.100% by mass or less (including 0% by mass);
S: 0.100% by mass or less (including 0% by mass);
Cu: 1.00% by mass or less (including 0% by mass);
Ni: 1.00% by mass or less (including 0% by mass);
Cr: 1.00% by mass or less (including 0% by mass);
Al: less than 0.030% by mass (including 0% by mass);
N: 0.0200% by mass or less (including 0% by mass); and
Sn: 0.002% by mass or more and 0.050% by mass or less, with the balance being iron and inevitable impurities, the soft magnetic wire rod or soft magnetic steel bar further including:
ferrite at an area ratio of 80% or more, wherein
the ferrite has a crystal grain size number of 5.0 or less, and
the soft magnetic wire rod or soft magnetic steel bar has a Vickers hardness of HV 140 or less.

Aspect 2 of the present invention provides the soft magnetic wire rod or soft magnetic steel bar according to aspect 1, wherein the Si content is 0.50% by mass or less (including 0% by mass).

Aspect 3 of the present invention provides the soft magnetic wire rod or soft magnetic steel bar according to aspect 1 or 2, further including: Mo: 1.00% by mass or less (not including 0% by mass).

Aspect 4 of the present invention provides the soft magnetic wire rod or soft magnetic steel bar according to any one of aspects 1 to 3, further including one or more selected from the group consisting of Ti: 0.100% by mass or less (not including 0% by mass), V: 0.100% by mass or less (not including 0% by mass), and Nb: 0.100% by mass or less (not including 0% by mass).

Aspect 5 of the present invention provides the soft magnetic wire rod or soft magnetic steel bar according to any one of aspects 1 to 4, further including: B: 0.0050% by mass or less (not including 0% by mass).

Aspect 6 of the present invention provides the soft magnetic wire rod or soft magnetic steel bar according to any one of aspects 1 to 5, further including ferrite at an area ratio of 90% or more.

Aspect 7 of the present invention provides a soft magnetic steel component, including:
C: 0.075% by mass or less (including 0% by mass);
Si: 1.00% by mass or less (including 0% by mass);
Mn: 0.10% by mass or more and 1.00% by mass or less;
P: 0.100% by mass or less (including 0% by mass);
S: 0.100% by mass or less (including 0% by mass);
Cu: 1.00% by mass or less (including 0% by mass);
Ni: 1.00% by mass or less (including 0% by mass);
Cr: 1.00% by mass or less (including 0% by mass);
Al: less than 0.030% by mass (including 0% by mass);
N: 0.0200% by mass or less (including 0% by mass); and
Sn: 0.002% by mass or more and 0.050% by mass or less, with the balance being iron and inevitable impurities, the soft magnetic steel component further including:
ferrite at an area ratio of 80% or more, wherein
the ferrite has a crystal grain size number of 5.0 or less, and
the soft magnetic steel component has a Vickers hardness of HV 140 or less.

Aspect 8 of the present invention provides the soft magnetic steel component according to aspect 7, wherein the Si content is 0.50% by mass or less (including 0% by mass).

Aspect 9 of the present invention provides the soft magnetic steel component according to aspect 7 or 8, further including: Mo: 1.00% by mass or less (not including 0% by mass).

Aspect 10 of the present invention provides the soft magnetic steel component according to any one of aspects 7 to 9, further including one or more selected from the group consisting of Ti: 0.100% by mass or less (not including 0% by mass), V: 0.100% by mass or less (not including 0% by mass), and Nb: 0.100% by mass or less (not including 0% by mass).

Aspect 11 of the present invention provides the soft magnetic steel component according to any one of aspects 7 to 10, further including: B: 0.0050% by mass or less (not including 0% by mass).

Aspect 12 of the present invention provides the soft magnetic steel component according to any one of aspects 7 to 11, further including ferrite at an area ratio of 90% or more.

### Effects of the Invention

According to one embodiment of the present invention, it is possible to provide a soft magnetic wire rod or soft magnetic steel bar and a soft magnetic component that have improved all of the magnetic properties (low coercive force), cold forgeability, and corrosion resistance, without adding a large amount of alloying elements.

### DETAILED DESCRIPTION

The inventors of the present application have intensively performed studied to solve the above-mentioned problems. As a result, inventors of the present application have found that excellent magnetic properties, excellent cold forgeability, and excellent corrosion resistance can all be achieved without adding a large amount of alloying elements, by appropriately adjusting the chemical composition, setting a ferrite fraction in its metal microstructure to 80% or more in area ratio, ensuring that a crystal grain size number of the ferrite is 5.0 or less, and setting a Vickers hardness to HV 140 or less.

Hereinafter, a detailed description will be given of each requirement specified by embodiments of the present invention.

### 1. Chemical Composition

The embodiments of the present invention are directed to a soft magnetic wire rod or soft magnetic steel bar and a soft magnetic component (also referred to as “soft magnetic steel component”). The chemical component will be described below. In the chemical composition of the wire rod, steel bar, and soft magnetic component according to the embodiments of the present invention, the content of an additive element is small as described below, allowing for reduced manufacturing costs.

As used herein, “wire rod” and “steel bar” have a circular cross-sectional shape perpendicular to the longitudinal direction in a preferred embodiment. However, they are not limited to this and may have any forms other than a circle, such as polygonal shapes including, for example, a square and a regular hexagonal shape. When the cross-sectional shape is not circular, the ratio of the length in the longitudinal direction to the length in the transverse direction within the cross-section is 2 or less. In the case of a wire rod, its diameter (or circular equivalent diameter of the cross-section of a shape other than a circle) is not particularly limited, but is, for example, 3.0 mm to 55 mm. In the case of a steel bar, its diameter (or circular equivalent diameter of the cross-section of a shape other than a circle) is not particularly limited, but is, for example, 18 mm to 105 mm.

### [C: 0.075% by Mass or Less (Including 0% by Mass)]

C is an element that controls the balance between the strength and ductility of steel material. The lower the amount added, the lower the strength and the more the ductility is improved. In order to reduce the C content, a vacuum degassing process or the like is performed, but it is difficult to reduce the C content completely to zero during a normal steel manufacturing process. The C content is normally about 0.001 to 0.010% by mass as impurities. Magnetic properties of the steel material become better as the ferrite fraction increases because ferrite is a ferromagnetic material. When the C content becomes excessive, the crystal grain size of ferrite becomes smaller, causing the crystal grain boundaries to hinder the movement of magnetic domain walls, resulting in the deterioration of magnetic properties. When the C content becomes more excessive (e.g., 0.100% by mass or more), the area ratio of ferrite decreases significantly, and the precipitation of cementite is also promoted, causing cementite to hinder the movement of magnetic domain walls, resulting in the deterioration of magnetic properties. When the C content is extremely large, the precipitation of cementite, which can serve as the starting point for cracking, becomes excessive, thus degrading cold forgeability. Furthermore, since cementite acts as a local battery under a corrosive environment, the corrosion resistance deteriorates when the C content is excessive and the amount of cementite increases significantly. Therefore, the upper limit of C content is set to 0.075% by mass, and the C content is preferably 0.060% by mass or less, and more preferably 0.050% by mass or less. C may be intentionally added as long as the C content is 0.075% by mass or less.

As used herein, “not including 0% by mass” means that the element is intentionally added, i.e., the content of the element exceeds the impurity level. Meanwhile, as used herein, “including 0% by mass” means that it encompasses embodiments in which the element is not intentionally added, that is, cases where the content of the element is at or below the inevitable impurity level (which does not exclude cases where the element is intentionally added).

### [Si: 1.00% by Mass or Less (Including 0% by Mass)]

Si exerts the effect of improving magnetic properties. To effectively demonstrate the above effect, Si may be added (i.e., not including 0% by mass). However, Si is not an essential element and may not be intentionally added (i.e., including 0% by mass) as long as the required magnetic properties can be satisfied. Si may be used as a deoxidizing agent when melted. It is difficult to reduce the Si content completely to zero in the normal steel manufacturing process, and the Si content is normally within the range of 0.005 to 0.01% by mass as the impurity. However, an excessive Si content degrades magnetic properties and cold forgeability. For this reason, the upper limit of Si content is set to 1.00% by mass. The Si content is preferably 0.75% by mass or less, more preferably 0.50% by mass or less, and even more preferably 0.30% by mass or less.

### [Mn: 0.10% by Mass or More and 1.00% by Mass or Less]

Mn effectively acts as a deoxidizing agent. Furthermore, Mn binds with S contained in a steel material to form MnS precipitates, which are then finely dispersed. Thus, these MnS precipitates serve as chip breakers for chips generated during a cutting process, contributing to improved machinability. To effectively demonstrate such an effect, the Mn content is set to 0.10% by mass or more. The Mn content is preferably 0.15% by mass or more, and more preferably 0.20% by mass or more. However, an excessive Mn content causes the magnetic properties and cold forgeability to deteriorate, and thus the Mn content is set to 1.00% by mass or less. The Mn content is preferably 0.75% by mass or less, and more preferably 0.50% by mass or less.

### [P: 0.100% by Mass or Less (Including 0% by Mass)]

P is an element that causes grain boundary segregation in a steel material, which deteriorates magnetic properties and cold forgeability, and is an inevitable impurity. Thus, the P content is reduced to 0.100% by mass or less to improve magnetic properties. The P content is preferably 0.075% by mass or less, and more preferably 0.050% by mass or less. The smaller the P content, the better it is. However, the P content is normally about 0.005% by mass.

### [S: 0.100% by Mass or Less (Including 0% by Mass)]

S is an element that causes grain boundary segregation in a steel material, which deteriorates magnetic properties and cold forgeability, and is an inevitable impurity. Thus, the S content is reduced to 0.100% by mass or less to improve magnetic properties. The S content is preferably 0.075% by mass or less, and more preferably 0.050% by mass or less. The smaller the S content, the better it is. However, the S content is normally about 0.005 to 0.010% by mass.

### [Cu: 1.00% by Mass or Less (Including 0% by Mass)]

Cu is an element that improves corrosion resistance. To effectively demonstrate the above effect, Cu may be added or may not be added intentionally, and thus the Cu content includes 0% by mass. In other words, the lower limit thereof is 0% by mass. When Cu is intentionally added, the Cu content is preferably 0.03% by mass or more. It is more preferably 0.05% by mass or more. However, an excessive Cu content reduces the magnetic moment of an Fe matrix phase and does not provide sufficient magnetic properties. Thus, the Cu content is set to 1.00% by mass or less. The Cu content is preferably 0.50% by mass or less, more preferably 0.30% by mass or less, and even more preferably 0.10% by mass or less. Even when no addition is made, the Cu content is normally about 0.01% by mass as the impurity level.

### [Ni: 1.00% by Mass or Less (Including 0% by Mass)]

Ni is an element that improves corrosion resistance. To effectively demonstrate the above effect, Ni may be added or may not be added intentionally, and thus the Ni content includes 0% by mass. In other words, the lower limit thereof is 0% by mass. When Ni is intentionally added, the Ni content is preferably 0.03% by mass or more. It is more preferably 0.05% by mass or more. However, an excessive Ni content reduces the magnetic moment of an Fe matrix phase and does not provide sufficient magnetic properties. Thus, the Ni content is set to 1.00% by mass or less. The Ni content is preferably 0.50% by mass or less, more preferably 0.30% by mass or less, and even more preferably 0.10% by mass or less. Even when no addition is made, the Ni content is normally about 0.01% by mass as the impurity level.

### [Cr: 1.00% by Mass or Less (Including 0% by Mass)]

Cr is an element that improves corrosion resistance. To effectively demonstrate the above effect, Cr may be added or may not be added intentionally, and thus the Cr content includes 0% by mass. In other words, the lower limit thereof is 0% by mass. When Cr is intentionally added, the Cr content is preferably 0.03% by mass or more. It is more preferably 0.05% by mass or more. However, an excessive Cr content reduces the magnetic moment of an Fe matrix phase and does not provide sufficient magnetic properties. Thus, the Cr content is set to 1.00% by mass or less. The Cr content is preferably 0.50% by mass or less, more preferably 0.30% by mass or less, and even more preferably 0.10% by mass or less. Even when no addition is made, the Cr content is normally about 0.01% by mass as the impurity level.

[Al: Less than 0.030% by Mass (Including 0% by Mass)]

Al is an element that reduces the magnetic moment of the Fe matrix phase and degrades magnetic properties. Furthermore, Al is an inevitable impurity that can combine with N in a steel material to form AlN. The AlN formed acts as pinning particles that inhibit crystal grain growth during an annealing process, thus increasing the number of crystal grain boundaries that hinder the movement of Al magnetic domain walls, thereby degrading magnetic properties. Cold forgeability also becomes deteriorated due to ferrite grain refinement caused by the suppression of crystal grain growth. Therefore, the Al content is set to less than 0.030% by mass. To demonstrate more excellent magnetic properties, the Al content is preferably 0.025% by mass or less, and more preferably 0.020% by mass or less. The smaller the Al content, the better it is. The Al content is normally about 0.001% by mass.

### [N: 0.0200% by Mass or Less (Including 0% by Mass)]

N is an inevitable impurity, and is solid-dissolved in a steel, causing a strain aging effect, which deteriorates cold forgeability. A large amount of N forms nitrides, which act as pinning particles to inhibit crystal grain growth during the annealing process. This increases the number of crystal grain boundaries that may hinder the movement of magnetic domain walls, thus degrading magnetic properties. In consideration of these factors, the upper limit of N content is set to 0.0200% by mass. The N content is preferably 0.0150% by mass or less, and more preferably 0.0100% by mass or less. The smaller the N content, the better it is. Thus, the N content is normally about 0.0010% by mass.

### [Sn: 0.002% by Mass or More and 0.050% by Mass or Less]

Sn is a particularly important element in the embodiments of the present invention. In a pure iron-based composition system having a low component content, such as the wire rod and steel bar and the soft magnetic component according to the embodiment of the present invention, elements are more likely to be diffused, and even a small amount of Sn forms a Sn-based oxide film on a surface layer, which demonstrates a significant effect of improving corrosion resistance. However, when the Sn content is extremely small, the formation of Sn-based oxide film is insufficient, which fails to obtain sufficient corrosion resistance. Thus, the Sn content is set to 0.002% by mass or more. The Sn content is preferably 0.004% by mass or more, more preferably 0.006% by mass or more, and even more preferably 0.010% by mass or more. A large amount of Sn degrades cold forgeability. In consideration of this, the upper limit of the Sn content is set to 0.050% by mass. The Sn content is preferably 0.045% by mass or less, and more preferably 0.040% by mass or less.

The basic components of the wire rod and steel bar and the soft magnetic component according to the embodiments herein are as mentioned above, and in one of the preferred embodiments, the balance includes iron and inevitable impurities. As inevitable impurities, the inclusion of elements (e.g., As, Sb, Ca, O, H, etc.) introduced by conditions such as raw materials, supplies, and manufacturing facilities is permitted.

It is noted that there are some elements such as P and S, for example, which are normally preferred in smaller contents, and are therefore inevitable impurities, but whose composition range is separately specified as mentioned above. For this reason, as used herein, “inevitable impurities” constituting the balance is a concept excluding elements whose composition range is separately specified.

### Other Optional Elements

Furthermore, in another preferred embodiment of the present invention, elements other than those mentioned above may be included as necessary to the extent that the action of the embodiment of the present invention is not impaired. Examples of such optional elements are given below. The properties of the steel are further improved according to the elements included.

### [Mo: 1.00% by Mass or Less (not Including 0% by Mass)]

Mo is an element that improves corrosion resistance. To effectively demonstrate this effect, Mo may be added. That is, the Mo content excludes 0% by mass, in other words, the lower limit thereof may be set to exceed 0% by mass. The Mo content is preferably 0.01% by mass or more. However, an excessive Mo content reduces the magnetic moment of the Fe matrix phase and degrades the magnetic properties. Thus, the Mo content may be 1.00% by mass or less. The Mo content is preferably 0.50% by mass or less, more preferably 0.30% by mass or less, and even more preferably 0.10% by mass or less.

[One or More Selected from the Group Consisting of Ti: 0.100% by Mass or Less (not Including 0% by Mass), V: 0.100% by Mass or Less (not Including 0% by Mass), and Nb: 0.100% by Mass or Less (not Including 0% by Mass)]

Ti, V, and Nb are carbide-forming elements. Since they produce carbides and reduce solid-solution C, they are effective in improving magnetic properties and cold forgeability by suppressing strain aging. For this reason, one or more selected from the group consisting of Ti, V, and Nb may be added. That is, the content of one or more selected from the group consisting of U, V, and Nb excludes 0% by mass, in other words, the lower limit thereof may exceed 0% by mass. The content of each of Ti, V, and Nb is preferably 0.005% by mass or more when added. However, an excessive content of each of Ti, V, and Nb inhibits crystal grain growth due to the pinning effect of the carbides, degrading magnetic properties. Therefore, when added, the content of each of Ti, V, and Nb elements is 0.100% by mass or less, preferably 0.075% by mass or less, and more preferably 0.050% by mass or less.

### [B: 0.0050% by Mass or Less (not Including 0% by Mass)]

B is an element that binds with N in a steel material to form BN, which reduces solid-solution N, thereby improving magnetic properties and cold forgeability by suppressing strain aging. To effectively demonstrate this effect, B may be added. That is, the B content excludes 0% by mass, in other words, the lower limit thereof may be set to exceed 0% by mass. The B content is preferably 0.0005% by mass or more. However, an excessive B content causes a compound such as Fe₂B to precipitate on crystal grain boundaries, thereby deteriorating magnetic properties. For this reason, when B is added, the B content is set to 0.0050% by mass or less. The B content is preferably 0.0040% by mass or less, and more preferably 0.0030% by mass or less. It is noted that the B content is normally about 0.0003% by mass as an impurity.

### 2. Metal Microstructure

### [Area Ratio of Ferrite of 80% or More]

In order to increase the magnetic moment of the Fe matrix phase, it is necessary to contain a large content of ferrite microstructure, which is a ferromagnetic material. When the proportion of ferrite microstructure is small, cold forgeability also deteriorates. For this reason, in the metal microstructure of the wire rod and steel bar and the soft magnetic component according to the embodiment of the present invention, the proportion of the ferrite microstructure (ferrite fraction) is set to 80.0% or more in area ratio. The area ratio of the ferrite microstructure is preferably 90.0% or more, more preferably 95.0% or more, and even more preferably 96.0% or more.

It is noted that when a microstructure other than ferrite is included, examples of such a microstructure include spheroidal cementite, pearlite, and bainite. For the sake of clarity, additionally, when pearlite is present, the layered ferrite within the pearlite is not counted as part of the ferrite in the ferrite area ratio.

### [Crystal Grain Size Number of Ferrite: 5.0 or Less]

When the crystal grain size of the wire rod and steel bar and the soft magnetic component is extremely small, the impact of crystal grain boundaries inhibiting the movement of magnetic domain walls becomes significant, leading to the degradation of magnetic properties. For this reason, it is necessary to increase the crystal grain size and reduce the presence density of crystal grain boundaries. Thus, in the wire rod and steel bar and the soft magnetic component according to the embodiments of the present invention, the ferrite crystal grain size number is 5.0 or less. The ferrite crystal grain size number is preferably 4.5 or less. From the viewpoint of achieving higher magnetic properties, the larger the crystal grain size, the better it is. However, it is difficult in terms of industrial production to achieve very large crystal grain sizes, and when the crystal grains are extremely coarse, the ductility and toughness are degraded, thus deteriorating cold forgeability. Thus, the ferrite crystal grain size number is preferably −3.0 or more, more preferably −1.0 or more, and even more preferably 0.0 or more.

The crystal grain size number can be determined by measurement according to the Japanese Industrial Standard G0511 (JIS G0511). For the sake of clarity, additionally, when pearlite is present, the layered ferrite within the pearlite is not counted as a subject for the measurement of the above ferrite crystal grain size number.

### 3. Vickers Hardness

Processing strain induced by hot working and cold working degrades magnetic properties. The inventors have found that excellent magnetic properties can be obtained by managing the Vickers hardness as a property that corresponds to the amount of working strain. Specifically, in the chemical component system of the embodiment according to the present invention, excellent magnetic properties can be obtained by setting the Vickers hardness to HV 140 or less. When the Vickers hardness exceeds HV 140, the magnetic properties deteriorate in response to a large amount of working strain. The Vickers hardness is preferably HV 130 or less, more preferably HV 120 or less, and even more preferably HV 115 or less.

The Vickers hardness is measured at a D/4 position (a position located at a distance of one fourth of a diameter D from a surface to the center, D being a circular equivalent diameter if the cross-sectional shape is not circular), which is a position representing the properties of a wire rod or steel bar. The hardness values are measured at three indentation points, each separated by 3d or more (d: diagonal length of the indentation) from one another, in accordance with JIS Z2224, and averaged to obtain a Vickers hardness. It is noted that the load is set to 1 kgf (9.81 N).

### 4. Manufacturing Method

The soft magnetic wire rod or steel bar according to the embodiment of the present invention can be manufactured by predetermined hot rolling or hot forging in a predetermined temperature range, followed by cooling under predetermined conditions, as mentioned below.

First, molten steel obtained by melting raw materials for steel production to satisfy the above component composition is cast to obtain a cast material. A method of obtaining a cast material may be the normal method used in the manufacture of a wire rod and a steel bar. Casting may be performed by a batch process to obtain ingots or by continuous casting. The cast material may be subjected to any process, such as facing, as necessary.

The resulting cast material is then heated to 950° C. to 1250° C., hot rolled or hot forged at 950° C. or higher to obtain a desired shape, and then cooled to 500° C. at an average cooling rate of 0.1° C./sec to 10° C./sec. Cooling in the temperature range of lower than 500° C. may be performed at any rate.

Thus, a ferrite microstructure with a predetermined area ratio and predetermined crystal grain size number, and a predetermined Vickers hardness can be obtained.

As mentioned above, wire rods or steel bars as used herein include those whose cross-sectional shape perpendicular to the longitudinal direction is a circle (or may be a cross-sectional shape other than a circle as mentioned above). This kind of wire rod or steel bar can be obtained by hot rolling or hot forging as mentioned above. In addition to this, the “steel wire” or “steel bar” of the present invention encompasses a steel wire or steel bar with the desired shape obtained by further performing cold working such as cold drawing after the hot rolling or hot forging. It is noted that since excessive cold working increases the ferrite crystal grain size number and Vickers hardness, a cold working rate (e.g., cold drawing rate) of 20% or less can be exemplified as a preferred processing condition. However, it should be noted that the amount of strain introduced varies depending on processing conditions such as processing speed and processing temperature, even at the same cold working rate, and that therefore the desired ferrite crystal grain size number and Vickers hardness can still be achieved even if the cold working rate exceeds 20%.

When the desired ferrite crystal grain size number and Vickers hardness cannot be obtained, magnetic annealing may be performed as necessary to obtain the desired ferrite crystal grain size number and Vickers hardness. Wire rods and steel bars obtained after the magnetic annealing include those subjected to magnetic annealing after hot rolling or hot forging, and those subjected to cold drawing after the hot rolling or hot forging, followed by magnetic annealing. The magnetic annealing is preferably performed under the conditions mentioned as magnetic annealing conditions mentioned in “4. Soft magnetic steel component” below. Any intermediate annealing may be performed during the cold drawing as long as the wire rod and steel bar finally obtained have the desired ferrite area ratio as well as the desired ferrite crystal grain size number and Vickers hardness.

The smaller the diameter of the wire rod and steel bar, the more the cold drawing is required, and the higher the cold drawing rate becomes. This further ensures that the magnetic annealing and intermediate annealing are required. Especially when the diameter is less than 3.0 mm, the number of times of annealing (total number of times of magnetic annealing and intermediate annealing) increases. Thus, the wire rod and steel bar according to the embodiment of the present invention preferably have a diameter or circular equivalent diameter of 3.0 mm or more.

### 5. Soft Magnetic Steel Component

The wire rod and steel bar according to the embodiment of the present invention can be used to perform one or both of processing and magnetic annealing on them, thereby obtaining a soft magnetic steel component. However, the soft magnetic steel component is not limited thereto. Other steel materials, especially other wire rods or steel bars, can be used to obtain soft magnetic steel components, as long as they have the above-mentioned chemical composition, ferrite area ratio, ferrite crystal grain size number, and Vickers hardness HV, which are specified in the wire rod and steel bar according to the embodiment of the present invention. The soft magnetic steel component obtained in this way is also included in the scope of the present invention. Soft magnetic steel components obtained using the wire rod or steel bar often have a circular or partially deformed circular outer periphery in the cross-section perpendicular to the axial direction (e.g., in one or more of a plurality of cross-sections when they are observed). However, this is not a feature of the soft magnetic components obtained from all types of wire rods or steel bars, and some components do not have this feature.

Soft magnetic steel components can include, for example, various electromagnetic components for automobiles, trains, and ships. These include iron core materials of electromagnetic valves, solenoids and relays; magnetic shielding materials, actuator members; and motor and sensor members.

When a soft magnetic wire rod or soft magnetic steel bar according to the embodiment of the present invention is used and formed into a desired component shape to obtain a soft magnetic steel component, a soft magnetic steel component may be obtained by cold forging this wire rod or steel bar, followed by magnetic annealing after the cold forging as necessary. When using a wire rod or steel bar that is different from the soft magnetic wire rod or steel bar according to the embodiment of the present invention but satisfies the chemical composition, the soft magnetic steel component according to the embodiment of the present invention may be obtained by cold forging and magnetic annealing after the cold forging. Since the ferrite crystal grain size number and Vickers hardness increase as the cold forging rate (the processing rate of the cold forging) increases, the cold forging rate is preferably 20% or less. In a case where the desired ferrite crystal grain size number and Vickers hardness cannot be obtained after the cold forging, magnetic annealing may be performed under the conditions mentioned below. Any intermediate annealing may be performed during the cold forging process as long as the final soft magnetic component achieves the desired ferrite area ratio, and desired ferrite crystal grain size number and Vickers hardness.

An example of the conditions for the magnetic annealing is maintaining the temperature at 700° C. to 1,000° C. for 1 to 5 hours. Under this condition, strain that deteriorates magnetic properties can also be removed. Although the cooling rate after maintaining the temperature is not particularly limited, it is preferable to perform cooling at an average cooling rate of 500° C./hour or less down to 400° C. in order to promote crystal grain growth and remove strain (reduce Vickers hardness). In this case, the cooling rate in a temperature range of lower than 400° C. is not particularly limited because it does not substantially affect crystal grain growth or thermal strain caused by cooling. However, air cooling or rapid cooling is preferred from the viewpoint of productivity. The atmosphere is not particularly limited, but it is preferable to perform processing in an inert gas atmosphere such as nitrogen, argon, or hydrogen.

After the magnetic annealing, surface treatments such as soft nitriding and plating do not change the ferrite area ratio or ferrite crystal grain size number. Thus, these treatments may be performed as necessary, as long as the desired Vickers hardness is satisfied.

The ferrite area ratio, ferrite crystal grain size number, and Vickers hardness of a soft magnetic steel component may be measured from the component surface to the inside of the component at a D′/4 position of the longest transverse line in the direction perpendicular to the component surface (D′ is the length of the longest transverse line in the cross-section).

### Examples

After melting specimens having the chemical compositions shown in Table 1 by a normal melting method, cast materials were obtained. The cast materials obtained were heated to 1,100° C., hot forged at 1,100° C., and subsequently cooled down to 500° C. for 10 minutes at an average cooling rate of 0.9° C./sec to produce wire rods with a diameter of 10 mm for samples Nos. 1 to 10, and with a diameter of 12 mm for samples Nos. 11 and 12. After the hot forging, the samples Nos. 11 and 12 were cold drawn to produce wire rod samples with a diameter of 10 mm in a single pass (drawing rate: approximately 30%). Sample No. 6 was further magnetically annealed by heating to 850° C., maintaining the temperature for 3 hours, and cooling down to 400° C. at an average cooling rate of 100° C./hour. Sample No. 12 was further magnetically annealed by heating to 550° C., maintaining the temperature for 30 minutes, and rapidly cooling with nitrogen gas.

Samples Nos. 4, 6 and 12 had the same composition, but differed in the presence or absence of the magnetic annealing and the conditions for the magnetic annealing as shown in Table 2.

As for the Si content, in samples Nos. 7 and 8, Si was intentionally added, while in the other samples, the Si content was at the impurity level. As for the content of each element of Cu, Ni, Cr, Mo, V, and Nb, in sample No. 9, these elements were intentionally added, while in the other samples, the contents of these elements were at the impurity level. As for the content of each element of Ti and B, in samples Nos. 9 and 10, these elements were intentionally added, while in the other samples, the contents of these elements were at the impurity level.

TABLE 1
Sample
Chemical composition (% by mass), Balance being Fe and inevitable impurities

| No | C | Si | Mn | P | S | Cu | Ni | Cr | Mo | Al | Sn | N | Ti | V | Nb | B |
|---|---|---|---|---|---|---|---|---|---|---|---|---|---|---|---|---|
| 1 | 0.001 | 0.005 | 0.23 | 0.006 | 0.003 | 0.01 | 0.01 | 0.01 | 0.00 | 0.001 | *0.001 | 0.0061 | 0.000 | 0.000 | 0.000 | 0.0002 |
| 2 | *0.08 | 0.01 | 0.24 | 0.007 | 0.005 | 0.01 | 0.01 | 0.01 | 0.00 | 0.003 | 0.009 | 0.0059 | 0.000 | 0.000 | 0.000 | 0.0002 |
| 3 | 0.004 | 0.01 | 0.24 | 0.007 | 0.004 | 10.01 | 0.01 | 0.01 | 0.00 | 0.001 | 0.010 | 0.0097 | 0.000 | 0.000 | 10.000 | 0.0002 |
| 4 | 0.001 | 0.01 | 0.24 | 10.006 | 0.005 | 0.01 | 0.01 | 0.01 | 0.00 | 0.002 | 0.033 | 0.0059 | 0.000 | 0.000 | 0.000 | 0.0002 |
| 5 | 0.001 | 0.01 | 0.23 | 0.007 | 0.004 | 0.01 | 0.01 | 0.01 | 0.00 | 0.002 | *0.052 | 0.0099 | 0.000 | 0.000 | 0.000 | 0.0003 |
| 6 | 0.001 | 0.01 | 0.24 | 0.006 | 0.005 | 0.01 | 0.01 | 0.01 | 0.00 | 0.002 | 0.033 | 0.0059 | 0.000 | 0.000 | 0.000 | 0.0002 |
| 7 | 0.004 | 0.24 | 0.24 | 0.007 | 0.004 | 0.01 | 0.01 | 0.01 | 0.00 | 0.001 | 0.019 | 0.0047 | \|0.001 | 0.000 | 0.000 | 0.0003 |
| 8 | 0.008 | 0.80 | 0.23 | 0.006 | 0.005 | 0.01 | 0.01 | 0.01 | 0.00 | 0.001 | 0.018 | 0.0047 | 0.001 | 0.000 | 0.000 | 0.0002 |
| 9. | 0.006 | 0.01 | 0.38 | 0.031 | 0.030 | 0.05 | 0.05 | 0.05 | 0.05 | 0.002 | 0.019 | 0.0062 | 0.004 | 0.008 | 0.009 | 0.0007 |
| 10 | 0.020 | 0.01 | 0.35 | 0.011 | 0.010 | 0.01 | 0.01 | 0.01 | 0.00 | *0.051 | *0.000 | 0.0093 | 0.020 | 0.000 | 0.000 | 0.0005 |
| 11 | 0.001 | 0.01 | 0.24 | 0.006 | 0.005 | 0.01 | 0.01 | 0.01 | 0.00 | 0.002 | 0.033 | 0.0059 | 0.000 | 0.000 | 0.000 | 0.0002 |
| 12 | 0.001 | 0.01 | 0.24 | 0.006 | 0.005 | 0.01 | 0.01 | 0.01 | 0.00 | 0.002 | 0.033 | 0.0059 | \|0.000 | 0.000 | 0.000 | 0.0002 |

*means that a value deviates from the range specified by the embodiment of the present invention.

For each sample, measurements of the ferrite area ratio (ferrite fraction) and ferrite grain size, Vickers hardness, and coercive force, as well as a corrosion resistance evaluation test and a cold forgeability evaluation test were conducted under the conditions shown below.

### (Measurement of Ferrite Area Ratio)

After mirror polishing the transverse section (cross-section perpendicular to the axis) of each sample, the metal microstructure was revealed by etching with nital. Three fields of view (each field of view being 950 to 1,200 μm in length and 1,900 to 2,400 μm in width) at the D/4 position (D: diameter of the wire rod sample) of the transverse section were photographed with an optical microscope at a magnification of 50 to 100 times. Ten vertical lines equally spaced and ten horizontal lines equally spaced were drawn on the taken photograph to form a grid. Consequently, 100 intersections between the vertical and horizontal lines were formed. The number of intersections (number of points of ferrite) located on the ferrite was measured out of the 100 intersections, and the ferrite area ratio was calculated from an occupancy rate of the intersections occupied by the ferrite. For each of the three photographs (three fields of view), the same processes were performed, and an average value of the ferrite area ratios (%) in the respective three fields of view was determined as the ferrite area ratio of the sample.

### (Ferrite Crystal Grain Size Number)

For each of the above samples, the crystal grain size number was determined in each of the photographs of the three fields of view according to the Japanese Industrial Standard G0511 (JIS G0511), and an average value thereof was determined as a value of the ferrite crystal grain size number of the sample.

### (Vickers Hardness Measurement)

The Vickers hardness of each sample was measured at the D/4 position (2.5 mm from the surface because of the diameter D of 10 mm). The hardness values were measured at three adjacent indentation points, each separated by 3d or more (d: diagonal length of the indentation) from one another, with a load of 1 kgf (9.81N) in accordance with JIS Z2224, and an average value of the hardness values at these three points was determined as the Vickers hardness.

### (Coercive Force Measurement)

The coercive force of each sample was measured as evaluation of magnetic properties. The measurement was performed using an automated coercive force meter Hc (manufactured by Tohoku Steel Co., Ltd. K-HC1000). Two measurement samples of φ8.0 mm×40.0 mm were fabricated by performing a cutting process on each original sample (by performing a cutting process so as to have φ8.0 mm such that the center line matched that of the wire rod sample of φ10 mm before processing), and the coercive force of each measurement sample was measured three times. The average value of the measurement results was calculated and determined as the coercive force of each sample. A magnetic field was applied to the cylindrical measurement sample such that the axial direction of the sample was parallel to the direction of magnetization when measuring the coercive force. When the coercive force was less than 100 A/m, the sample was judged to have good magnetic properties.

### (Corrosion Resistance Evaluation Test)

A corrosion resistance evaluation test sample of φ5.0 mm×20.0 mm was fabricated by performing a cutting process on each sample (by performing a cutting process to have φ5.0 mm such that the center line matched that of the wire rod sample of φ10 mm before processing). These corrosion resistance evaluation test samples were immersed in a 1% H₂SO₄ solution for 24 hours (Hr) at room temperature in a beaker test, while stirring the solution. The corrosion weight loss was then measured after the test. The “corrosion weight loss” was determined by dividing the change in mass of a test piece before and after the immersion by an initial surface area of the test piece.

When the corrosion weight loss was 70 g/m² or less, the specimen was judged to have good corrosion resistance.

### (Cold Forgeability Evaluation Test)

A cold forgeability test sample of φ8.0 mm×12.0 mm was fabricated by performing a cutting process on each original sample (by performing a cutting process so as to have φ8.0 mm such that the center line matched that of the wire rod sample of φ10 mm before processing). The cold forgeability test was performed twice on these cold forgeability test samples at room temperature using a forging press at a strain rate of 5/sec to 10/sec at a processing rate of 80%. The cold forgeability test at the processing rate of 80% will be described in more detail. A cylindrical cold forging test sample with a height of 12.0 mm was compressed in a direction parallel to the axial direction of the cylindrical shape until its height reached 2.4 mm. In each cold forgeability test, the deformation resistance at the processing rate of 40% was measured. The average value of the deformation resistances obtained was determined as the deformation resistance of the sample. When the deformation resistance of the sample is 460 MPa or less, the sample was judged to have good cold forgeability. The crystal grain size number, ferrite area ratio, Vickers hardness, coercive force, corrosion weight loss and deformation resistance, measured by the above methods are shown in Table 2.

TABLE 2

| | Presence | | | | | Property evaluation results | | | |
|---|---|---|---|---|---|---|---|---|---|
| | or absence | | | Metal | | | Corrosive | | |
| | of cold | | | microstructure | | | weight loss | | |
| | working | Presence or | | Crystal | | | (g/m²) | Deformation | |
| | before | absence of | Vickers | grain | Ferrite | Coercive | @Sulphuric | resistance | |
| Sample | magnetic | magnetic | hardness | size | area | force | acid 1%, | (MPa) | |
| No | annealing | annealing | (HV) | number | ratio | (A/m) | 24 hours | @40% | |
| 1 | Absence | Absence | 102 | 4.3 | 100% | 70 | *79 | 414 | Comparative |
| | | | | | | | | | Example |
| 2 | Absence | Absence | 114 | *6.3 | 95% | *166 | *98 | *483 | Comparative |
| | | | | | | | | | Example |
| 3 | Absence | Absence | 106 | 4.0 | 100% | 82 | 53 | 448 | Inventive |
| | | | | | | | | | Example |
| 4 | Absence | Absence | 107 | 3.3 | 100% | 79 | 33 | 431 | Inventive |
| | | | | | | | | | Example |
| 5 | Absence | Absence | 98 | 4.5 | 100% | 81 | 38 | *466 | Comparative |
| | | | | | | | | | Example |
| 6 | Absence | Presence | 89 | 2.5 | 100% | 36 | 32 | 362 | Inventive |
| | | 850° C. × | | | | | | | Example |
| | | 3 hours → | | | | | | | |
| | | 100° C./hour | | | | | | | |
| | | (slow | | | | | | | |
| | | cooling to | | | | | | | |
| | | 400° C.) | | | | | | | |
| 7 | Absence | Absence | 103 | 4.5 | 100% | 57 | 70 | 388 | Inventive |
| | | | | | | | | | Example |
| 8 | Absence | Absence | 119 | 3.9 | 100% | 47 | 60 | 431 | Inventive |
| | | | | | | | | | Example |
| 9 | Absence | Absence | 101 | 4.5 | 100% | 96 | 29 | 362 | Inventive |
| | | | | | | | | | Example |
| 10 | Absence | Absence | 113 | *8.5 | 97% | *233 | *174 | *483 | Comparative |
| | | | | | | | | | Example |
| 11 | Presence | Absence | *184 | *5.1 | 100% | *269 | 25 | 448 | Comparative |
| | (cold | | | | | | | | Example |
| | working | | | | | | | | |
| | rate of | | | | | | | | |
| | 30%) | | | | | | | | |
| 12 | Presence | Presence | *142 | 4.3 | 100% | *123 | 15 | 405 | Comparative |
| | (cold | 550° C. × | | | | | | | Example |
| | working | 30 minutes → | | | | | | | |
| | rate of | Rapid | | | | | | | |
| | 30%) | cooling with | | | | | | | |
| | | nitrogen gas | | | | | | | |

*means that a value deviates from the range specified by the embodiment of the present invention.

Samples Nos. 3, 4 and 6 to 9 satisfied all of the component composition, ferrite area ratio, ferrite crystal grain size number, and Vickers hardness, specified by the embodiment of the present invention, and they had good results in terms of all the magnetic properties, corrosion resistance and cold forgeability.

Among these, sample No. 6 is a magnetically annealed sample, and even after magnetic annealing, it satisfies all of the component composition, ferrite area ratio, ferrite crystal grain size number, and Vickers hardness, and had excellent magnetic properties, corrosion resistance and cold forgeability.

Sample No. 1 had an extremely small Sn content, resulting in inferior corrosion resistance.

Sample No. 2 had an excessive C content and an excessive crystal grain size number, and was inferior in terms of all magnetic properties, cold forgeability, and corrosion resistance.

Sample No. 5 had an excessive Sn content, resulting in inferior cold forgeability.

Sample No. 10 had no Sn added and an excessive Al content, resulting in inferior corrosion resistance and magnetic properties.

Sample No. 11 had a significant cold working rate and was not subjected to magnetic annealing, resulting in excessive Vickers hardness and inferior magnetic properties.

Sample No. 12 had a significant cold working rate and an extremely low magnetic annealing temperature, resulting in a significant Vickers hardness and inferior magnetic properties.

This application claims priority based on Japanese Patent Application No. 2022-037304 filed on Mar. 10, 2022, and Japanese Patent Application No. 2022-186848 filed on Nov. 22, 2022, the disclosures of which are incorporated by reference herein.

1. A soft magnetic wire rod or soft magnetic steel bar, comprising, in mass percentage:
Fe;
C in a range of from 0 to 0.075%;
Si in a range of from 0 to 1.00%;
Mn in a range of from 0.10 to 1.00%;
P in a range of from 0 to 0.100%;
S in a range of from 0 to 0.100%;
Cu in a range of from 0 to 1.00%;
Ni in a range of from 0 to 1.00%;
Cr in a range of from 0 to 1.00%;
Al in a range of from 0 to less than 0.030%;
N in a range of from 0 to 0.0200%;
Sn in a range of from 0.002 to 0.050%,
wherein the soft magnetic wire rod or soft magnetic steel bar comprises ferrite at an area ratio of 80% or more,
wherein the ferrite has a crystal grain size number of 5.0 or less, and
wherein the soft magnetic wire rod or soft magnetic steel bar has a Vickers hardness of HV 140 or less.

2. The rod or bar of claim 1, comprising, in mass percentage:
(a) the Si in a range of from 0 to 0.50%;
(b) Mo in a range of from greater than 0 to 1.00%;
(c) Ti in a range of from greater than 0 to 0.100%, V in a range of from greater than 0 to 0.100%, and/or Nb in a range of from greater than 0 to 0.100%; and/or
(d) B in a range of from greater than 0 to 0.0050%.

3. The rod or bar of claim 1, wherein the area ratio of the ferrite is 90% or more.

4. A soft magnetic steel component, comprising, in mass percentage:
Fe;
C in a range of from 0 to 0.075%;
Si in a range of from 0 to 1.00%;
Mn in a range of from 0.10 to 1.00%;
P in a range of from 0 to 0.100%;
S in a range of from 0 to 0.100%;
Cu in a range of from 0 to 1.00%;
Ni in a range of from 0 to 1.00%;
Cr in a range of from 0 to 1.00%;
Al in a range of from 0 to less than 0.030%;
N in a range of from 0 to 0.0200%;
Sn in a range of from 0.002 to 0.050%,
wherein the soft magnetic steel component comprises ferrite at an area ratio of 80% or more,
wherein the ferrite has a crystal grain size number of 5.0 or less, and
wherein the soft magnetic steel component has a Vickers hardness of HV 140 or less.

5. The component of claim 4, comprising, in mass percentage:
(a) the Si in a range of from 0 to 0.50%;
(b) Mo in a range of from greater than 0 to 1.00%;
(c) Ti in a range of from greater than 0 to 0.100%, V in a range of from greater than 0 to 0.100%, and/or Nb in a range of from greater than 0 to 0.100%; and/or
(d) B in a range of from greater than 0 to 0.0050%.

6. The component of claim 4, wherein the area ratio of the ferrite is 90% or more.

7. The rod or bar of claim 2, wherein the area ratio of the ferrite is 90% or more.

8. The rod or bar of claim 1, comprising the Si in a range of from 0 to 0.50% by mass.

9. The rod or bar of claim 1, further comprising:
Mo in a range of from greater than 0 to 1.00% by mass.

10. The rod or bar of claim 1, further comprising:
Ti in a range of from greater than 0 to 0.100% by mass.

11. The rod or bar of claim 1, further comprising:
V in a range of from greater than 0 to 0.100% by mass.

12. The rod or bar of claim 1, further comprising:
Nb in a range of from greater than 0 to 0.100% by mass.

13. The rod or bar of claim 1, further comprising:
B in a range of from greater than 0 to 0.0050%.

14. The rod or bar of claim 1, further comprising:
Mo in a range of from greater than 0 to 1.00% by mass; and
Ti in a range of from greater than 0 to 0.100% by mass.

15. The rod or bar of claim 1, further comprising:
Mo in a range of from greater than 0 to 1.00% by mass; and
V in a range of from greater than 0 to 0.100% by mass.

16. The rod or bar of claim 1, further comprising:
Mo in a range of from greater than 0 to 1.00% by mass;
Ti in a range of from greater than 0 to 0.100% by mass; and
V in a range of from greater than 0 to 0.100% by mass.

17. The component of claim 5, wherein the area ratio of the ferrite is 90% or more.
